(19) United States
(12) Patent Application Publication
(10) Pub. No.: US 2022/0283088 A1
(43) Pub. Date: Sep. 8, 2022

(54) VIRAL LOAD TESTER AND APPLICATIONS THEREOF

(71) Applicant: Joshua David Silver, Oxfordshire (GB)

(72) Inventor: Joshua David Silver, Oxfordshire (GB)

(21) Appl. No.: 17/470,244

(22) Filed: Sep. 9, 2021

(30) Foreign Application Priority Data
Feb. 3, 2021 (GB) 2101490.7
Feb. 6, 2021 (GB) 2101671.2
May 31, 2021 (GB) 2107752.4

(51) Int. Cl. G01N 21/64

(52) U.S. Cl. CPC G01N 21/6456; G01N 2201/062

(57) ABSTRACT

The technology described herein provides a system and method for measuring an amount of virus in a sample to be tested. The system comprises a light emitting diode operable to emit UV light towards a sample to be tested, and a detector operable to detect light from fluorescence events induced in a sample by UV light emitted from the light emitting diode. An amount of virus in the sample is then estimated based on at least the light from fluorescence events that is detected by the detector.

### CROSS-REFERENCE TO RELATED APPLICATION

This application claims priority from and the benefit of United Kingdom Patent Application No. 2101490.7 filed 3 Feb. 2021, United Kingdom Patent Application No. 2101671.2 filed 6 Feb. 2021, and United Kingdom Patent Application No. 2107752.4 filed 31 May 2021. The entire contents of these applications are incorporated herein by reference.

### BACKGROUND

The technology described herein relates to the detection and measurement of viral loads in samples to be tested and in particular to the detection and measurement of viral loads using UV induced visible fluorescence detection.

Traditional virological analysis is a time-consuming and expensive process. It is however known that viruses exhibit UV induced fluorescence following ultra-violet (UV) laser excitation, and that the visible fluorescence may be used to aid the detection of viruses. It is also known that the viral loads (an amount of a virus or viruses in a sample), observed in patients infected with viruses can be extremely high. For example, a patient infected with the SARS-Cov-2 virus may have on the order of one billion RNA copies found in a single nasopharyngeal or saliva swab.

However, such virological analysis using specialised UV lasers and the necessary auxiliary components is impractical, and too expensive, for general use.

The Applicant believes therefore that there remains a need for an inexpensive and effective viral load tester to aid in the detection of viral infections. In one example, such a test for COVID-19 infections would be suitable for global usage, and, when combined with suitable and effective quarantine procedures, would assist with global containment and eradication of the COVID-19 pandemic.

### BRIEF DESCRIPTION OF THE DRAWINGS

A number of embodiments of the technology described herein will now be described by way of example only and with reference to the accompanying drawings, in which:

FIG. 1 is a schematic diagram of a viral load testing system according to an embodiment of the technology described herein;

FIG. 2 is a flowchart of a method for operating the viral load testing system according to an embodiment of the technology described herein.

FIG. 3 is a flowchart of a method for estimating a viral load of a sample according to an embodiment of the technology described herein; and

FIG. 4 is a diagram of an example viral load testing kit according to an embodiment of the technology described herein.

### DETAILED DESCRIPTION

A first embodiment of the technology described herein comprises a system for measuring an amount of virus in a sample to be tested, the system comprising a light emitting diode and a detector. The light emitting diode is operable to emit UV light towards a sample to be tested, and the detector is operable to detect light from fluorescence events induced in a sample by the UV light emitted from the light emitting diode. The detector is further configured to provide an output representative of the viral load of the sample based on the detected light from the induced fluorescence.

The technology described herein uses UV induced fluorescence to detect the presence of viruses in samples to be tested for the presence of viruses. In particular, a sample is irradiated with UV light and the visible fluorescence from any viruses present in the sample (such as SARS-CoV-2) is detected. However, in the technology described herein, rather than using a UV laser to illuminate the sample, a UV LED is used as a source of UV radiation. The applicants have realised that it is possible to utilise UV LEDs in place of traditional laser UV sources to provide a viable viral load tester with sufficient sensitivity for assessing the viral load of a sample. Beneficially, by utilising mass-produced UV LEDs, the tester may be produced far more cheaply to provide a tester suitable for cost-effective mass testing.

The Applicants have further recognised that the visible fluorescence observed from a sample (such as one taken from a saliva or nasopharyngeal swab) may be used as a measure of a patient's viral load. For example, as a patient infected with SARS-Cov-2 virus may have on the order of one billion RNA copies found per nasopharyngeal or saliva swab, the UV induced fluorescence of a sample may provide an indication of a SARS-CoV-2 infection, particularly if the test is performed in a location suffering from an outbreak of the virus.

Thus, detecting and measuring the light from UV induced fluorescence events in a sample can provide a suitable indication of whether a patient is infected with a virus. Accordingly, a viral load test using the technology described herein may be utilised as a cost effective, accurate and fast substitute for determining whether a patient is infected with a virus. This approach simplifies the detection and analysis required for detecting viral infections due to the high viral load of certain viruses.

The low cost of manufacturing the technology described herein, combined with the long life of the system due to the inexpensiveness and reliability of suitable LEDs (which can often be used tens of thousands of times) may further reduce the test cost essentially to little more than the cost of providing the sample. It is envisioned that the present device may be manufactured for under GBP 100, thereby reducing the typical cost of a test for viral infections such as a COVID-19 infection to under GBP 0.01 excluding the cost of a suitable swab.

The sample that is being tested may comprise any sample that may contain one or more viruses. For example, the sample may be disposed on a slide such as a silica slide, for example by wiping the slide with a swab or cotton that has been used to take a saliva sample, or using a pipette such as an exact volume transfer pipette.

The sample may be appropriately sealed, for example using a seal such as a waterproof plaster, to prevent transmission of any viruses to the user.

The system in an embodiment includes a mount for holding the sample (e.g. a slide holder for holding a slide onto which the sample has been disposed). The mount is in an embodiment fixable and, when performing a test positionally fixed, relative to the UV LED and/or the detector, thereby to assist in accurately positioning the sample for testing. For example, the mount may be a sample slide holder and the sample may be disposed on a slide which is slotted into the holder.

The mount may be movable between a first position for mounting the sample and a second position for testing the sample.

The use of a mount helps ensure that subsequent samples are placed in a similar or the same location for each test, thereby helping to ensure consistency across multiple measurements and improving the ease with which tests can be compared to one another.

The UV LED can be any suitable and desired LED that can act as a source of UV radiation, and is in an embodiment a UV-C LED. The UV LED in an embodiment has a power between 40 mW and 100 mW, however LEDs with a power greater than or less than these values may also be used. The UV LED in an embodiment emits UV light with a wavelength between 250 nm and 290 nm, and in an embodiment around 272 nm.

The detector can be any suitable detector that can detect the fluorescence events from a sample being tested. The detector is in an embodiment a semiconductor device and in an embodiment a photodiode. In an example, the detector is a multi-pixel photon counter (MPPC).The detector is in an embodiment configured to detect visible light of about 350 nm to 600 nm, and in an embodiment of (around) 500 nm.

In an embodiment, the detector is a suitable multi-element photodetector, and in an embodiment a two-dimensional multi-element photodetector (comprising a two dimensional array of detection elements). For example the detector may comprise one or more CMOS sensors.

In an embodiment, the detector is provided by or as part of an external device. For example, the detector may be provided by a suitable mobile device such as a smart phone, or any other external device that includes a digital camera.

The LED-sample-photodetector system should be, and in an embodiment is, arranged so as to image any fluorescence of the sample onto the photodetector, so as to fall within its active photo-detection area. The detector in an embodiment outputs an electrical signal based on the detected light. In some embodiments, the output current is approximately proportional to the intensity of the detected fluorescence events.

The detector is in an embodiment positioned relative to the sample and the UV LED in order to reduce the amount of UV radiation entering the detector. In an embodiment, the detector, UV LED and sample are not positioned along a single axis. The detector is in an embodiment positioned outside of the emission cone of the UV LED so as to try to minimise the amount of UV light entering the detector from the UV LED. For example, if the UV LED and sample are separated along a first direction, the detector is in an embodiment separated from the sample in a second direction that is perpendicular to the first direction. By positioning the detector from the sample along a direction approximately perpendicular to the UV LED-sample axis, the amount of scattered UV light from the sample that enters the detector is reduced, further assisting in minimising the noise from the UV light. In an embodiment, the sample is disposed on a slide, and the slide is positioned at an approximately 45 degree angle to each of the UV LED and the detector.

The system optionally comprises a UV filter to reduce the amount of scattered UV radiation from the sample and/or any mount that arrives at the detector, and/or to suppress background UV radiation. The UV filter is in an embodiment positioned between the sample and the detector. The UV filter in an embodiment attenuates approximately the wavelength of UV light as emitted by the UV LED, but will transmit the visible light from the induced fluorescence events.

The system may also or instead comprise a dispersive element to reduce the amount of UV background radiation entering the detector. The dispersive element may be, for example, a grating, prism or any other optical element suitable for suppressing background radiation. Such a dispersive element can also in principle assist in the identification of the virus under study, if it has sufficient spectral resolution.

The Applicant has recognised that if the power of the UV light at the sample is too low, the accuracy of the test may decrease. For example, below a threshold UV power per unit area, some of the viruses in the sample may not exhibit fluorescence in a given test. Thus, in an embodiment, the system is configured such that the UV light provides a power of at least about 1 mW and in an embodiment a power of per unit area of at least about 1 mW/mm2 at the sample.

Correspondingly, the system in an embodiment comprises a lens to focus the emitted UV light on the sample and thereby increase the intensity of the UV light on the sample. The lens may be e.g. a convex lens positioned between the UV LED and the sample. Alternatively, other optical components may be used to focus the UV light, such as one or more mirrors.

Thus, in general, the system in an embodiment comprises one or more optical components for focusing the UV light onto the sample.

For ease of description, the remainder of the specification will refer primarily to the use of lenses for focusing and directing (any) light, but it should be understood that in all embodiments such lenses may be substituted for or combined with any other suitable optical components, such as mirrors.

The Applicant has further recognised that the UV light penetrates into a sample to a depth related to the transmissibility of the sample for the specific wavelength of UV light. Therefore, by illuminating the sample with a spot that is smaller than the sample itself, a volume of the tested sample can be estimated (e.g. based on the area of the spot and the expected depth that the UV radiation will penetrate to). The viral load per unit volume of the sample (e.g. a measure of the amount of virus present per mL of a sample) can then be estimated based on this volume and any estimate of the amount of virus in the sample. In an embodiment therefore, the lens (or other focusing component) is arranged to focus the UV light into an area at the sample which is smaller than the area of the sample.

Additionally or alternatively, the system in an embodiment comprises one or more lenses (or other focusing components, such as one or more mirrors) to focus the light from the sample towards the detector. The lenses may be convex lenses positioned between the sample and the detector to image the fluorescence onto the detector. The system may comprise a single lens for imaging the fluorescence onto the detector, or may comprise a first one or more lenses to focus the light towards any UV filter and/dispersive element and a second one or more lenses to focus the filtered light towards the detector.

As discussed above, a sample with a higher viral load will generally produce brighter fluorescence events for a given intensity of incident UV light. The increased brightness is a result of a larger number of viruses acting as sources for the induced fluorescence.

Therefore, in an embodiment, an image of the sample during fluorescence is processed in order to estimate the number of viruses in the sample. The Applicant has recognised that each virus in a sample effectively acts as a point source of the visible fluorescence, such that the number of fluorescence “point sources” in an image of the sample will provide a measure of the number of viruses in the sample.

Thus, the number of point sources of the fluorescence light in an image of the sample is in an embodiment counted or estimated in order to estimate a number of viruses in a sample. The counting can be performed by appropriate image processing of an image of the sample e.g. using dedicated hardware or by software. Alternatively, the image may be transmitted to an external device for processing. For example, the image may be processed by a cloud-based server system.

This approach advantageously assists in accounting for (and “removing”) any fluorescence that may be due to contaminating matter in a sample (i.e. non-virus caused fluorescence) that may otherwise impact the resulting viral load estimation. For example, any fluorescence caused by contaminants can be removed during the processing of the image based on e.g. the size and/or the intensity distribution of the different fluorescence sources in the image, even if the fluorescence light caused by the contaminants has a same or similar wavelength(s) as the fluorescence light caused by the virus.

In some embodiments, the image of the sample is processed using any suitable technique to reduce distortions of the fluorescence light introduced by the device. For example, the image may be deconvolved to reduce distortions of the point sources in the image. As the viruses in the sample effectively act as “point sources”, the fluorescence light from the viruses in the resultant image of the sample may be distorted by the point spread function (PSF) of the optical equipment used in the device, such as the lenses. The convolution of the PSF and the point sources results in a spreading or blurring of fluorescence light from the viruses in the image. These distortions may reduce the accuracy of the count of the viruses. By processing (and deconvolving) the image before counting the number of point sources, the PSF may be removed from the image to reduce the blurring or spreading of the point sources of the fluorescence light.

In an embodiment, the UV LED and the detector are configured to illuminate the sample and measure an intensity of the fluorescence. The UV LED can illuminate the sample for a short period of time such that the detector provides an instantaneous or near instantaneous measurement of the intensity of the fluorescence.

An estimate of the amount of a virus in a sample is in an embodiment then based on a peak intensity of the fluorescence, an average intensity of the fluorescence, or on a combination of the peak and average intensity of the fluorescence. The measured intensity of the fluorescence may be compared to a threshold value to determine whether a person has a viral infection (and in one embodiment that is done). Additionally or alternatively, the intensity of the light detected by the detector may be used to estimate the viral load of the sample, for example via the use of a predetermined relationship between the viral load of a sample and the intensity of the corresponding fluorescence events. In some embodiments, the estimated viral load may then be compared to a threshold value to determine whether a person has a viral infection based on the comparison.

In an embodiment, the system in an embodiment estimates an amount of virus in the sample via multiple methods in order to improve the reliability of the estimate. For example, the system may calculate an estimate of the amount of virus in the sample based on both the intensity of the detected light and a number of point sources for the detected light.

In an embodiment, an estimate of the viral load per unit volume (e.g. an estimate of the amount of virus per millilitre of the sample) is determined.

In an embodiment, the system is used to estimate a viral load of several samples that are provided by a single person over an extended period of time. For example, a new and different sample from the person may be tested each day. In this embodiment, it may be determined that the person has a viral infection if a (sufficiently) large change (i.e. increase) in the estimated viral load (e.g. exceeding a threshold “change” in the estimated viral load) is detected. Accordingly, the system in an embodiment comprises one or more memory units for storing data for previous tests. Additionally or alternatively, past test data may be transmitted to and stored by a third party, as will be discussed further below. The system correspondingly in an embodiment includes one or more processors for processing the measurements or images of the detected light from the detector to determine the test “result” (and, in an embodiment, to provide a corresponding output to that effect). The one or more processors may form part of the detector, or may otherwise be a separate component to which the appropriate signals from the detector are provided. In an embodiment, the processors are part of an external device, such as any a suitable computing device. For example, the measurements or images may be transmitted to a mobile phone or a cloud-based server system for processing and/or to provide an estimate of the viral load of the sample.

The system in an embodiment comprises a display for providing test results to the user. The display may be a digital display for displaying the result of the viral load test. For example, the output result may be a number representing the viral load of the sample, and/or an indication of whether the person who provided the sample has a viral infection. In either case, the result may be displayed visually on the display. Alternatively the display may be replaced by or combined with e.g. one or more lights for indicating whether a virus or viral infection has been detected. For example, a red light may be used to indicate that a person has a viral infection, while a green light may indicate that the person does not have a viral infection.

The display is in an embodiment a touch screen display to allow the user to interact with and control the system. Additional or alternative input methods (such as buttons or dials) may also be used.

Additionally or alternatively, the results may be communicated wirelessly, or otherwise via a plug-in connection, to a computing device such as a mobile phone. The computing device may replace the display as the primary means for providing the test results to the user or may be used in combination with the display. The computing device may further enable the results to be efficiently communicated to an office or institution which is monitoring or recording the spread of viral infections, such as COVID-19.

The system in an embodiment comprises a GPS chip so that real time infection location information can be included in any transmitted data for storing in appropriate database.

In an embodiment, the system can be, and in an embodiment, is, calibrated using calibration information. The calibration information may be determined by any suitable means. For example, the system can calibrated using sample(s) with known viral loads at a range of UV LED outputs, and the results recorded as the calibration information. In an embodiment, the sample(s) with known viral loads are used in order to determine a relationship between the characteristics of the fluorescence events (e.g. the intensity or number of point sources) and one or more of, and in an embodiment both of, the viral load of a sample and the power of the UV radiation. The calibration information may be stored in e.g. one or more memory units of the system for use in (and used for) estimating the viral load of tested samples.

The system in an embodiment comprises a second detector for monitoring the intensity of light emitted from the UV LED. A decrease in the intensity of the UV light may result in a decrease in a brightness of the sample, for example as a result of fewer of the viruses in the sample being excited and exhibiting induced fluorescence. Thus, the second detector is in an embodiment used to monitor fluctuations in the output of the UV LED, thereby allowing the system to account for these fluctuations when estimating the viral load. For example, a threshold viral load representing an infected sample may be increased or decreased depending on, and in accordance with, any changes in the output of the UV LED. In embodiments, this may result in a change in the number of point sources and/or a change in the threshold intensity of the fluorescence light required for the sample to be considered to be infected.

In an embodiment, calibration information relating to the impact of fluctuations in the UV LED output on the fluorescence events (e.g. the intensity) and the measured viral load of a sample is (determined and) used to account for any fluctuations detected by the second detector. This calibration information may e.g., be stored in one or more memory units of the system for use in accounting for any fluctuations detected by the second detector. The second detector may be any suitable detector, and is in an embodiment a semiconductor device, such as a photodiode.

The components of the system are in an embodiment mounted within a housing. The housing in an embodiment includes support structures for the components of the system, such that the components may be fixed within the housing relative to one another. The housing may therefore assist in reducing any unwanted relative movement of the components both during and between viral load tests. Beneficially, the housing may also protect the components from accidental damage, reduce the amount of background light entering the detector and improve the ease with which the system may be transported.

The housing may include one or more slots, panels or any other suitable openings for inserting and removing test samples. In one example, the samples are disposed onto slides, and the housing includes a slot for inserting and removing the sample slides. The opening is in an embodiment aligned with any mount for the sample, such that inserting the slide into the slot also inserts the sample into or onto the mount.

The display is in an embodiment set in an outside surface of the housing to be visible to the user during use of the viral load tester.

The system in an embodiment comprises an interface for controlling the system. The interface may, for example, comprises one or more of: a touch screen, a button or buttons, and a dial or dials. For example, the housing may include one or more buttons or dials for starting and ending a test. In an embodiment, the display provides a user interface to assist the user in controlling the system. For example, the display can be touch screen display and the user interface may include one or more buttons for starting and/or ending a test, and may also allow the user to configure test settings such as test duration. The system interface may include a combination of different input means, for example comprising both buttons and/or dials in the housing and a touch screen display.

It is envisioned that the system may be used and configured to detect and identify the presence of and/or estimate a viral load for a specific type of virus (for example SARS-CoV-2) in a sample (or of multiple different virus types, if desired) based on the particular spectrum of the fluorescence detected from the sample.

In particular, the Applicants have recognised that the fluorescence light may be analysed to identify particular virus types present in a sample. For example, the colour (e.g. wavelength) of the fluorescence light can provide an indication of the virus type(s) in a sample, and can therefore be used both to identify whether a virus is present in a sample and what type(s) of virus are present. Additionally or alternatively, similar analysis can be performed based on e.g. a detected peak wavelength of the fluorescence light, or by determining the full spectrum of the fluorescence light from the sample. For example, the fluorescence spectrum of a sample may be compared to reference spectra for different virus types to determine the type(s) of virus present in a sample.

The technology described herein also extends to performing tests to measure a viral load of a sample using the viral load test system. Thus, a second embodiment of the technology described herein comprises a method of measuring an amount of virus in a sample to be tested using a system as previously described, the method comprising: emitting UV light towards the sample to be tested using the light emitting diode, detecting light from fluorescence events induced in the sample by the UV light, and estimating the viral load of a sample based on the light from fluorescence events.

The method in an embodiment comprises providing an output indicative of the estimated viral load of the sample.

The method in an embodiment comprises providing the output indicative of the estimated viral load of the sample by counting or estimating a number of point sources of the fluorescence light. Providing the output indicative of the estimated viral load of the sample further in an embodiment comprises deconvolving an image of the sample prior to counting or estimating the number of point sources.

The method in an embodiment comprises estimating a viral load of a sample based on the intensity of the UV Light emitted by the UV LED.

The method in an embodiment comprises transmitting an indication of the test result to a third party.

The method in an embodiment comprises comparing the viral load of the sample with the viral load of a previous sample.

An embodiment of the technology described herein will now be described.

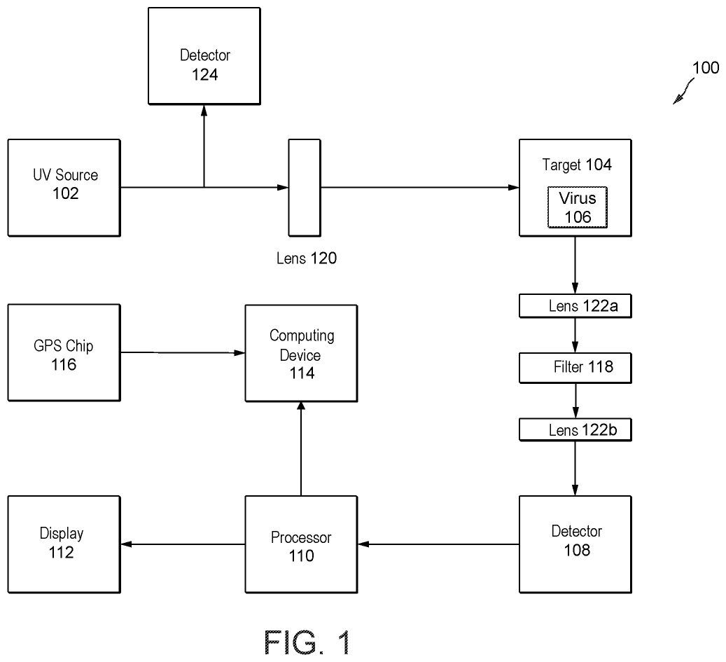

FIG. 1 is a schematic diagram of a viral load testing system 100. The system 100 comprises a UV LED 102 such as a UV-C LED that provides a source of UV light. The UV LED 102 may have a power between 40 and 100 mW and may emit UV light with a wavelength of 272 nm. For example, UV LED 102 may be a Laser Components S6060-DR250-W272-P 100 100 mW UV-C LED or a Laser Components 3535-40 or 3535-100 40 mW or 100 mW UV LED. The system 100 includes a power supply (not shown) for the UV LED 102, such as a 5V current controlled power supply.

The UV LED 102 is operable to emit UV light towards a target 104 comprising a virus sample 106. The sample 106 may be, for example, a saliva sample on a slide. The incident UV light from UV LED 102 induces fluorescence in the virus sample 106. The light from the induced fluorescence is then detected by a detector 108. Detector 108 may be a photodetector such as a photodiode, or any other suitable detector.

In one example, incident UV light with a wavelength of approximately 272 nm may be used to induce fluorescence in viruses such as SARS-CoV-2, and the detector 108 may be configured to detect visible light of about 450 nm to 600 nm, or about 500 nm. More generally, any wavelength of UV light suitable for inducing fluorescence in samples containing viruses may be used.

The target 104 may be positioned at an angle to the incident UV light. By angling the target 104 and sample 106, it is possible to reduce the amount to scattered UV light arriving at detector 108 and thereby reduce background noise. In one example, the target 104 is an Alfa Aesar fused quartz microscope slide positioned at a 45 degrees angle to the incident UV radiation.

Optionally, the system 100 may include a suitable structure for supporting the target 104 and assisting with the positioning of the sample. In one example, the structure may be e.g. a stand for mounting the target. Alternatively, the structure may be a container for the sample and the structure may form part of the target 104. In this case, the user may position the sample 106 by placing it within the target container 104. In an embodiment, any container for the sample 106 is formed from a material with a relatively high transmission for UV light, such as fused silica.

Detector 108 may be positioned such that UV LED 102, target 104 and the detector 108 are not placed along a single axis. Merely as an example, the UV LED 102 may be positioned above the target 104, while the detector 108 may be positioned to a side of the target 104. By suitable positioning of the detector 108, it is possible to position the detector outside of the emission cone of the UV LED 102, thereby reducing the amount of UV light from the UV LED entering the detector. Moreover, by positioning the detector 108 relative to the target 104 such that a line between the detector 108 and the target 104 is approximately perpendicular to a line between the target 104 and the UV LED 102 (as in the above example), the amount of scattered UV light from the target 104 that enters the detector 108 can also be reduced.

It will be understood that detector 108 may be provided by an external device, such as a digital camera with a suitable lens or a camera for a smart phone.

Generally, for a given intensity of incident UV light, the brightness of the fluorescence events induced in a sample will vary with the viral load of the sample, for example, as a result of an increase in the number of viruses acting as “point sources” for the fluorescence light. This means that the intensity of fluorescence events induced in a sample with a higher viral load will be greater than the intensity of fluorescence events induced in a sample with a lower viral load, in addition to the sample having a larger number of point sources for the fluorescence light.

The detector 108 may include processing circuitry such as one or more processors 110 for calculating the viral load of the sample 106 based on the light detected by the detector 108 from the fluorescence events induced in sample 106. Alternatively, processors 110 may be separate from the detector 108.

In an example, the detector may be a Hamamatsu PMMA S13360-1325cs. In another example, the detector may be any suitable camera device, for example a microscope camera such as a YINAMA 4.3 Inch HD 1080P Wireless Microscope. The detector may comprise or be combined with suitable electronic circuitry for converting the visible fluorescent radiation into digital and/or analogue signals. These signals can then be used by the processor(s) to estimate a viral load of the sample.

Optionally, the UV light from the UV LED 102 may be focused onto the target 104 by a lens 120, such as a convex lens. By focusing the UV light towards the target, lens 120 effectively increases the intensity of the UV light at the target, thereby strengthening the fluorescence events. In an example, the lens may be a Thorlabs LA 4647 fused silica 12.7 mm diameter 20 mm focal length lens and focus the light UV into an approximately 1 mm by 1 mm focus at the target 104.

A filter 118 is positioned between the target 104 and the detector 108 to reduce the amount of unwanted light arriving the detector 108 from the target 104. Filter 118 assists in reducing the amount of noise detected by the detector 108, thereby improving the accuracy of the results. The filter 118 may, for example, pass wavelengths of the expected fluorescence light from the sample, but block other (unwanted) wavelengths. Additionally or alternatively to filter 118, the system 100 may include one or more dispersive elements such as a prism or grating to further reduce the amount of unwanted (e.g. background) radiation entering the detector.

Lenses 122a and 122b assist in focusing the light from the target 104 towards the detector 108 and/or the filter 118. The system 100 may include one, both or neither of lenses 122a and 122b. Lenses 122a and 122b may be convex lenses that image the fluorescence from the target 104 onto the photodetector. In this way, lenses 122a and 122b may provide greater precision in the measurements of the detector 108. Lens 122a focuses light from the target 104 towards the filter 118, while lens 122b focuses light from the filter 118 to the detector 108. Alternatively, if the system 100 does not include a filter 118 or any dispersive elements either or both of lenses 122a and 122b may be used to focus the fluorescence from target 104 at detector 108. In an example, the system may comprise a single lens 122 such as a Thorlabs LA1951 one inch diameter lens with a focal length of 25.4 mm. Lenses 122a and b may additionally or alternatively magnify the sample for imaging by the detector 108. For example, detector 122 and one or both of lenses 122a and b may be components of an imaging device such as a digital camera or digital microscope for capturing an image of the sample during the fluorescence event. Lenses 122a and/or b may provide a magnification of up to 1000× or more.

A second detector 124 may be used to monitor the emissions of UV LED 102. The second detector 124 may be, for example, a photodiode configured to detect UV light emitted by the UV LED 102. The second detector 124 is used to measure fluctuations in the output of UV LED 102. These measurements can then be provided to processors 110 so that processors 110 can base the viral load estimates on both the measured intensity of the incident UV light and the detected light from the fluorescence events. Generally speaking, the intensity of the UV induced fluorescence events in the sample will vary depending on the intensity of the incident UV light. Beneficially therefore, by providing a measurement of the intensity of the UV light emitted by the UV LED 102, any changes to the output of UV LEDs 102 due to, for example, a change in temperature between measurements, can be accounted for when estimating a viral load of a sample 106.

The system 100 may include a display device 112 such as a digital display to display the test results to the user. The display 112 may be any suitable display for displaying the result values. Additionally or alternatively, the system may comprise a set of lights to indicate whether the sample includes traces of a virus, for example a green light to indicate that no or only a small amount of viruses are present in the sample and a red light to indicate the presence of viruses in the sample, or that the sample has a high viral load. The system 100 may include both a digital display and a set of lights. For example, the system 100 may be used to detect a high viral load typically associated with viral infections such as COVID-19. The system 100 may therefore comprise both a display 112 for displaying the test results to the user and a light system to indicate whether a COVID-19 infection is probable. Alternatively, this indication could be provided on the digital display.

The detector system 100 may also include a communications module to enable the system 100 to communicate viral load test results to a third party, for example via the internet. Additionally or alternatively, the communications module may enable system 100 to communicate with a computing device 114 such as a mobile device. Device 114 may be connected to the system 100 wirelessly, for example over Bluetooth®, or over a wired connection. The computing device 114 may be used in place of the display 112 to provide results to the user and/or computing device may be used to communicate viral load test results to a third party. In an example, following a test for SARS-CoV-2 the device 114 may transmit the results to an office or institution which is monitoring the spread of the COVID-19 infection. The computing device 114 may store previous test results, for example for comparison with later tests. Alternatively, previous test results may be stored by detector system 100 using an inbuilt memory, or by the third party, or any combination thereof.

The system 100 in an embodiment includes a GPS chip 116 to provide location data, which may be included with any transmitted data. After the transmission, the result and/or location data may be stored in an appropriate database.

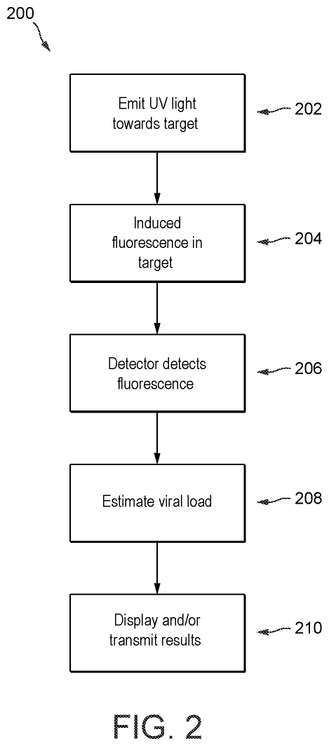

FIG. 2 is a flow diagram 200 depicting a method for measuring a viral load of a sample using the system of the present embodiments.

In step 202, a sample is irradiated with UV light from the UV LED 102.

In step 204, the incident UV light induces fluorescence in the sample 104. The intensity of and number of point sources for the fluorescence of the sample 104 is related to the viral load of the sample 104.

In step 206, the visible fluorescence light is detected by the detector 108.

In step 208, the detected visible fluorescence light is used to estimate a viral load of the sample, for example by using an intensity of the light or by counting a number of point sources.

In step 210, the results of the viral load test are displayed to the user and/or transmitted to a relevant third party, optionally along with geographical location data.

In some embodiments, the results of the viral load test are stored in a database or otherwise saved in a system memory. The method of FIG. 2 may then be repeated for other samples from the same person to track a viral load of the person over an extended period of time. For example, samples from a person may be tested daily.

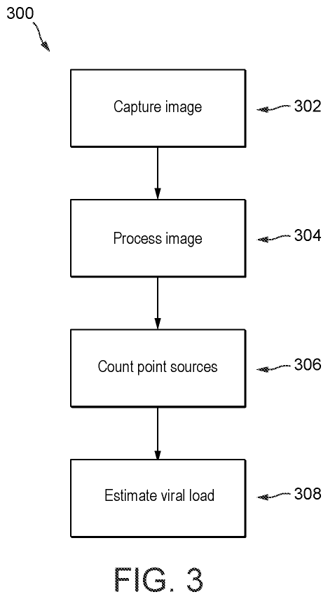

FIG. 3 is a flow diagram 300 depicting an example of a method for estimating the viral load of a sample.

In step 302 the detector captures an image of the sample during fluorescence. The image may be captured by any suitable photodetector, including for example a digital camera such as a smart phone camera.

In step 304, the image is processed. The processing can be performed using any suitable technique. For example, the processing the image may comprise deconvolving the intensity distribution of the sample and the point spread function of the system.

In step 306, the image is further processed to count or estimate a number of point sources in the sample. The counting or estimating may be performed by any suitable software or hardware, such as an application for a mobile phone.

In step 308, a viral load is estimated based on the number of point sources in the sample. Due to the size of the viruses, each virus in the sample effectively acts as a “point source” for the fluorescence light. Therefore, the number of viruses in a sample (and thus the viral load of the sample) can be estimated by counting or estimating the number of point sources for the fluorescence light, with each point source corresponding to a single virus in the sample.

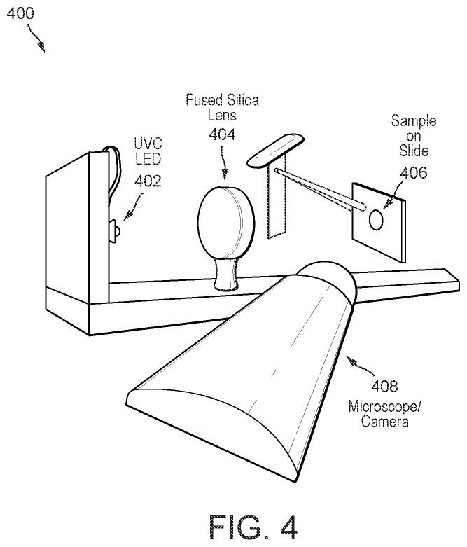

FIG. 4 is a diagram of an example viral load testing kit 400 in accordance with the technology described herein. The kit 400 includes a UVC LED 402, a fused silica lens 404, a sample disposed on a sample slide 406, and a microscope or camera 408. In this example, the UVC LED 402 illuminates the sample, and the resulting fluorescence light is detected and analysed by microscope/camera 408. While FIG. 4 shows the system as a kit with separate components, this is an example provided to assist in the understanding of the embodiment. It will be appreciated that these and other components may be combined into a single device. For example, the device may comprise a housing to contain and positionally secure the components.

The viral load testing kit 400 may further include one or more hardware components such as memory systems and/or processors.

Although the present embodiments have been described above with particular reference to estimating the viral load, it would also be possible to use, e.g. a feature or features of the spectrum of the detected fluorescence light to try to identify the type of virus that is present, if desired. For example, the spectrum of fluorescence could be determined (e.g. by appropriate spectral or image analysis) and compared to a library of reference spectra from different virus types.

Whilst the foregoing detailed description has been presented for the purposes of illustration and description, it is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

What is claimed is:

1. A system for measuring an amount of virus in a sample to be tested, the system comprising:
a light emitting diode configured to emit UV light towards a sample to be tested; and
a detector configured to detect light from fluorescence events induced in a sample by UV light emitted from the light emitting diode.

2. The system of claim 1, wherein the system further comprises a filter for reducing the amount of unwanted light entering the detector.

3. The system of claim 1, further comprising a mount for holding a sample to be tested.

4. The system of claim 1, further comprising a component for directing the emitted UV light towards a sample to be tested.

5. The system of claim 1, further comprising one or more components for directing light from induced fluorescence events to the detector.

6. The system of claim 1, wherein the system is configured to provide an output representative of the amount of virus in a sample based on a count of a number of point sources of the detected light.

7. The system of claim 1, wherein the system is configured to provide an output representative of the amount of virus in a sample based on an intensity of the detected light.

8. The system of claim 1, wherein the detector is a photodiode or a two-dimensional array of detection elements.

9. The system of claim 1, further comprising a communications module configured to transfer data to a computing device.

10. The system of claim 1, wherein the light emitting diode and the detector are fixedly mounted within a housing.

11. The system of claim 1, further comprising a second detector configured to detect UV light emitted by the light emitting diode, wherein the detected UV light is used to determine an intensity of the UV light; and
wherein the system is configured to provide an output representative of the amount of virus in a sample based on an intensity of the detected light from fluorescence events and the determined intensity of the UV light.

12. The system of claim 1, wherein the UV light has a wavelength of between 250 nm and 300 nm, optionally wherein the wavelength of the UV light is about 272 nm.

13. The system of claim 1, wherein the detector is configured to detect light from the fluorescence events with a wavelength between 350 nm and 600 nm.

14. A method of measuring an amount of virus in a sample to be tested using a system comprising:
a light emitting diode configured to emit UV light towards a sample to be tested; and
a detector configured to detect light from fluorescence events induced in a sample by the UV light emitted from the light emitting diode;
the method comprising:
emitting, from the light emitting diode, UV light towards the sample to be tested;
detecting, at the detector, light from fluorescence events induced by the UV light; and
estimating, based on at least the detected light from fluorescence events, an amount of virus in the sample.

15. The method of claim 14, further comprising transmitting an indication of an amount of a virus in the sample to a third party.

16. The method of claim 14, wherein estimating the amount of virus in the sample comprises counting a number of point sources for the detected light.

17. The method of claim 16, wherein estimating the amount of virus in the sample further comprises processing an image of the sample prior to counting the number of point sources.

18. The method of claim 14, wherein estimating the amount of virus in the sample comprises estimating the amount of virus in the sample based on an intensity of the detected light from fluorescence events.

19. The method of claim 14, the system further comprising a second detector configured to detect UV light emitted by the light emitting diode, wherein the method further comprises:
detecting UV light emitted from the light emitting diode;
determining an intensity of the emitted UV light; and
estimating the amount of virus in the sample further based on the determined intensity of the emitted UV light.

20. The method of claim 14, wherein the method further comprises comparing the estimated amount of virus in the sample to an estimated amount of virus in a previous sample.
